(19) United States
(12) Patent Application Publication
(10) Pub. No.: US 2012/0101609 A1
(43) Pub. Date: Apr. 26, 2012

(54) Audio Auditioning Device

(75) Inventors: Ben Supper, Middlesex (GB); Mathew Derbyshire, Cardiff (GB); Robert Jenkins, High Wycombe (GB)

(73) Assignee: FOCUSRITE AUDIO ENGINEERING LTD, High Wycombe, Buckinghamshire (GB)

(21) Appl. No.: 13/379,907

(22) PCT Filed: Jun. 15, 2010
(86) PCT No.: PCT/GB2010/001165

§ 371 Date: Dec. 21, 2011

(30) Foreign Application Priority Data
Jun. 16, 2009 (GB) 0910315.1

(51) Int. Cl. G06F 17/00

(52) U.S. Cl. 700/94

(57) ABSTRACT

Accurate “Mixing” of a sound signal has hitherto required a recording studio environment. Currently, both professional music producers facing budgetary limitations and amateur music makers without access to such meet a difficulty in producing music which has been correctly “Mixed” and “Auditioned”. We therefore propose a “Mixing” and “Mix Audition” tool, which can use standard headphones as the method of reproducing the direct sound, together with a DSP system that can be used with a computer based music production system to simulate specific listening experiences. The present invention therefore provides an audio auditioning device comprising a sound input, a sound output, a digital signal processor, and a library of stored digital signal processor effects, wherein the digital signal processor is adapted to apply a chosen effect from the library to a sound signal provided to the device via the sound input and deliver this to the output, and the library includes a plurality of digital signal processor effects representing the effect on a sound signal of reproduction in different environments. The digital signal processor applies the chosen effect in real time. The effects can include a home stereo, a home multi channel cinema, a large cinema, a concert hall, a car interior, and a radio receiver, or the like. The audio auditioning device can be combined with a computing device which includes a stored sound signal, mixing software adapted to adjust the mix of the stored sound signal, and a sound output connected to the sound input of the audio auditioning device.

### CROSS-REFERENCE TO RELATED APPLICATION

This Application is a Section 371 National Stage Application of International Application No. PCT/GB2010/001165, filed Jun. 15, 2010 and published as WO 2010/146346 A1 on Dec. 23, 2010, the content of which is hereby incorporated by reference in its entirety.

### FIELD

The present invention relates to an audio processing device.

### BACKGROUND

Music is reproduced to the public in many different environments. In many (or most) of these, the quality of experience is compromised by both the listening space and by the method of reproduction of the direct sound. The various environments include (without limitation) home stereo, home multi channel cinema, large cinema, concert hall, car interiors, and radio receivers.

The quality control of the listening experience of a particular piece of music is managed by employing a professional mix engineer, under the instructions of a music producer. The engineer balances and equalises the music, and may add effects such as reverberation and echo, in a process known as “Mixing”, in which the source music is balanced and equalised within a known environment, such as a professional recording studio, in order to create a sound track with adjusted tonal qualities. The aim is to achieve the desired sound of the music, known as the “Mix”. The finished “Mix” is then auditioned within different environments, to see whether it retains the necessary tonal qualities. This auditioning step allows the music producer to experience the qualitative effect of the various environments upon the sound of the “Mix” and thus make any necessary adjustments to the original “Mix” to compensate for those effects and ensure that the “Mix” has an acceptable sound quality across the range of environments for which it is intended.

The overall object of this process is to produce a single “Mix” of the music (or other recording) that can be reproduced within all the anticipated environments to an acceptable level of quality, as determined by the music producer.

### SUMMARY

The introduction of computer-based music production systems and the free distribution of digital music has eroded the financial value of musical content severely, thus creating both problems for existing traditional music producers and also opportunities for new low cost music producers.

As a result, it is no longer economically viable for many professional music producers to use the traditional method of “Mixing”, i.e. within a recording studio environment, to create content and to fully audition the quality of musical content. Conversely, it is now easier for amateur music makers to make musical content using only a computer laptop and suitable music production software. However, such amateur music is often unmixed, or at least un-auditioned, for obvious reasons of cost and practicality.

In this new paradigm, particularly the absence of a professional recording studio environment for mixing, both professional music producers and amateur music makers meet a difficulty in producing music which has been correctly “Mixed” and “Auditioned” in order to provide adequate control of the sound quality.

We therefore propose a “Mixing” and “Mix Audition” tool, which can use standard headphones as the method of reproducing the direct sound, together with a DSP system that can be used with a computer based music production system to simulate specific listening experiences and thereby replicate the auditioning process.

The present invention therefore provides an audio auditioning device comprising a sound input, a sound output, a digital signal processor, and a library of stored digital signal processor effects, wherein the digital signal processor is adapted to apply a chosen effect from the library to a sound signal provided to the device via the sound input and deliver this to the output. The library includes a plurality of digital signal processor effects representing the effect on a sound signal of reproduction in different environments, and the digital signal processor is adapted to apply the chosen effect in real time.

Each effect will (generally) be a combination of a loudspeaker model, a room model and a head model. Each effect can thereby replicate one auditioning environment of the plurality of auditioning environments that can be or need to be tried. Thus, after a proposed mix has been created by the user, the present invention can be used to audition that mix in a range of environments whilst still working from the same computing device and listening via the same headphones.

The effects can include a home stereo, a home multi channel cinema, a large cinema, a concert hall, a car interior, and a radio receiver, or the like.

Each effect is preferably a combination of a loudspeaker model and a room model, to give a combined effect of listening to a specific type of loudspeaker and a specific room environment. This also permits the loudspeakers and the rooms to be interchanged, giving a wider range of possible audition parameters. Each effect preferably further includes a human head model so that the final audio signal as heard through headphones accurately mimics the sound heard by a human listener in the relevant environment.

The models can be derived mathematically, or from measured impulse responses. Mathematical derivation is generally preferred as this furnishes accurate information more easily than a recording, and permits post-hoc customisation of the room. Measurement of impulse responses can also be used; however. This involves sending a known brief signal into the environment concerned and observing the resulting sound pattern. A candidate loudspeaker can be tested this way in an anechoic chamber or in a chamber whose parameters are known (and which can therefore be subtracted), to obtain the characteristics of the loudspeaker. A room can then be tested using a known loudspeaker in order to obtain the characteristics of the room.

The digital signal processor preferably applies the effect to the sound signal via both convolution reverberation and Schroeder reverberation. As discussed later, this allows a fast and accurate response with minimal computing overhead.

The apparatus may comprise a pair of headphones connectable to the sound output of the audio auditioning device, with each of the digital signal processor effects comprising a combination of an environment-specific effect and an effect corresponding to the headphones. Each of the digital signal processor effects may also comprise an effect corresponding to a human head model.

The audio auditioning device can be combined with a computing device which includes a stored sound signal, mixing software adapted to adjust the mix of the stored sound signal, and a sound output connected to the sound input of the audio processing device.

The computing device is preferably adapted to retain a sound file for processing by the mixing software. The mixing software is preferably adapted to adjust audio parameters of the sound file and save a new version of the sound file to the computing device.

Alternatively, the audio auditioning device can be used to monitor live sound. For example, there are a number of historical spaces (often used for classical music recording) where the recording engineer necessarily shares the room with the artists, and so cannot use loudspeakers to balance the live sound.

### BRIEF DESCRIPTION OF THE DRAWINGS

An embodiment of the present invention will now be described by way of example, with reference to the accompanying figures in which;

FIG. 1 shows the functional elements of the invention and how they interact, and

FIG. 2 shows the physical arrangement of the device and associated items.

### DETAILED DESCRIPTION OF ILLUSTRATIVE EMBODIMENTS

This audio tool has two unique applications

1. A customisable and (potentially) mobile “Mixing” environment.

2. A method of auditioning the “Mix” in different environments.

Our solution creates an accurate environment within which any listening experience can be simulated. The variables of spatial dimensions, the listener's head position within the space and the specific sound reproduction system can be modified to accurately model the different environments.

For those music producers who are either on the move, mixing outside of a studio environment, or do not have a studio of any kind they can reproduce the sound of their own studio or the combination of any other recording studio room and specific studio monitors.

For those music producers who do not have the facilities or budgets to audition musical content in many different environments the tool can reproduce the sound of any sound reproduction system within any space.

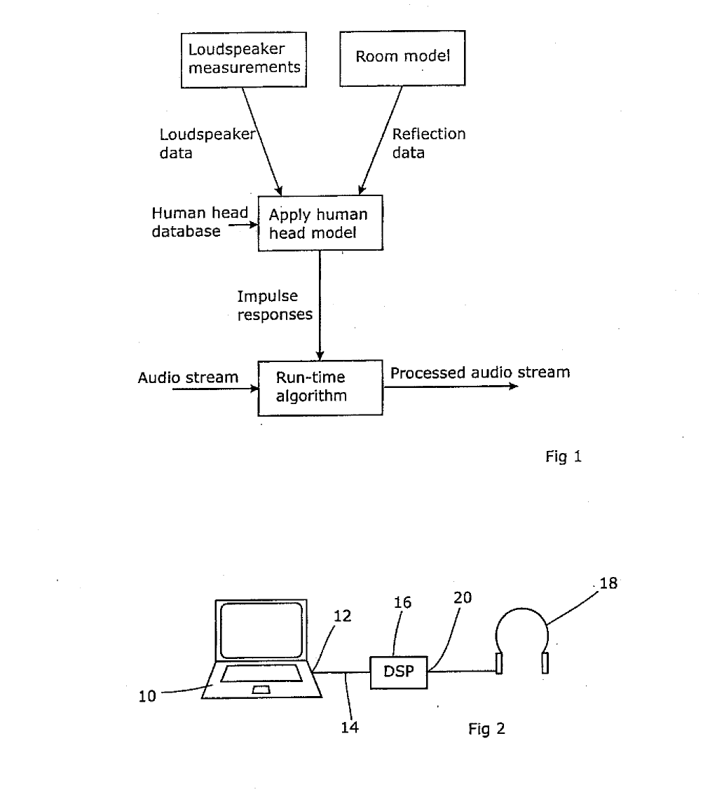

The model works via a combination of four principal components. Three are used to build the simulation: a loudspeaker measurement database, a room model, and a human head model. The fourth is the run-time algorithm, which runs on a DSP and applies the simulation to audio in real time, as shown in FIG. 1.

The loudspeaker measurements are obtained by sampling each loudspeaker in a standard room at two distances and in thirteen directions. A measurement stimulus is chosen so that non-linear distortion from the loudspeaker is reduced during sampling, as this would corrupt the measurement. Acoustic reflections from the (known) measurement room are computed out, so what remains is the anechoic, direction-dependent characteristics of each loudspeaker. When a stereo pair of loudspeakers is available, frontal responses from both loudspeakers are taken so that any disparities between the two loudspeakers can be included accurately in the model.

The impulse for these measurements is generated in the frequency domain, giving rise to a flat, continuous spectrum. By dividing this spectrum into twelve sections and boosting the lower stimuli in inverse proportion to frequencies, a partitioned stimulus can be derived that:

i. Can exploit the dynamic range of the loudspeaker without driving it to its distortion limit at high frequencies;

ii. Spreads the signal in time, reducing the influence of noise from the room and the measuring microphone;

iii. Presents only a small portion of the frequency response at any time, so that the loudspeaker does not warm up causing power compression, while intermodulation distortion caused by the Doppler effect is drastically reduced;

iv. After equalisation to counteract the lower-frequency boosting, will mathematically sum to an impulse response.

A short pilot tone is added to the beginning of the stimulus to allow for synchronisation, so that processing and acoustic transmission delays can be eliminated. If desired, non-linear distortion effects can also be modelled, based on the size of the loudspeaker.

The room model is a mathematical model of a rectangular room or other environment. Included in it are the positions of the loudspeaker and listener, the acoustic characteristics of each surface, and simple objects within the room. What results is a complete set of reflections describing the reverberation of the room, its diffusive properties, the angles of emergence and incidence, and the spectral shaping that affects each reflection.

To combine the loudspeaker and room models into something that a listener will be able to hear, a human head model is employed. This is a database which uses equalisation, distance correction, interpolation, and retiming techniques as set out below. This characterises the manner in which sound incident from any direction around a listener is changed by the outer ears, the acoustic shadowing of the listener's head, and the relative distances between the ears.

In relation to the head-related impulse responses, great care is needed as a result of two aspects of the human hearing system. First, sensitivity to interaural delays is exquisite. Listeners can hear disparities of 10 microseconds of arrival between the left and right ears, and perceive these as shifts in the image position. Second, to get accurate measurements of the effect of the head, torso, and outer ears on incident sound waves, the measurement microphones must be placed within ‘ear canals’ of a dummy head.

The spectral shaping of the signal obtained here is therefore somewhat different to the one required when replaying the signal through headphones—the signal would be shaped twice, were the impulses not equalised to account for this.

The method of equalisation and correction is described in stages below.

i. The impulse response database was recorded with the reference loudspeaker at 1.4 metres from the dummy head. This produces angular distortion, because when a loudspeaker is placed at such a close distance, the wavefront reaches each ear at an angle of approximately three degrees owing to the head's physical width. This disparity is audible, so we find the true angle of incidence of each stimulus using trigonometry, and correct for it in further processing.

ii. The co-ordinates are transformed from the standard polar system in which they were recorded (azimuth and elevation) into a more psychoacoustically useful system (cone angle and cone elevation: the ‘cone angle’ refers to a conical locus around the aural axis in which interaural timing and level differences are almost identical). Transforming the incident angles into this domain groups cues that are psychoacoustically similar. This aids weighting during the subsequent interpolation process, and the curve fitting of interaural time differences applied in the next step.

iii. We reduce each impulse response to minimum phase, and extract the time difference. The time differences are modelled using a peculiar combination of polynomial curves, so that an appropriate time difference can determined and applied at each point in our output data set.

iv. The average spectrum of the input data set is determined for subsequent equalisation.

v. In order to increase the spatial resolution of the data set, we use weighted interpolation based on the conical domain, and a time difference for each position derived using our polynomial curves. The 720 measurements in the database are interpolated to form 8010 measurements, to match the sensitivity of the human auditory system.

vi. A combination of the average spectrum of the input data (step iv) and the frontal spectrum of the interpolated data is used to equalise the entire data set. This produces the best compromise between linearity of perceived frequency response (furnished by frontal spectrum equalisation), and perceived realism (furnished by average spectrum equalisation).

The loudspeaker can thus be positioned arbitrarily in a virtual environment, and a set of impulse responses generated which closely approximate how a listener would experience the sound in a real environment.

A run-time algorithm running on the device then applies these impulse responses to a stream of audio. The algorithm is a hybrid of two existing practices: convolution reverberation and Schroeder reverberation. Convolution reverberation accurately reproduces the direct sound and the precise reflection patterns of the first 60 ms of reverberant sound in the simulation. This is responsible for making the room acoustics and distances in the simulation sound convincing. The Schroeder reverberation covers later reflections, and is adjusted to the room model to match its spectral shape, decay time, reflection density, and interaural correlation, so that the transition between the two models is seamless. This overcomes the challenge of producing a very accurate simulation with a short processing delay on an inexpensive processor.

FIG. 2 shows the physical arrangement of devices. A computing device 10 such as a laptop, personal computer, or the like holds a sound file that requires mixing The computing device is also provided with suitable mixing software that allows a user to vary the parameters of the mix and output the mixed sound signal via an audio output 12. This is delivered via a cable 14 to the sound auditioning device 16, and the user can listen to its output via headphones 18 connected to an audio output 20 provided on the device 16.

Thus, the user can propose various draft mixes and audition them live via the controlled environment that is provided by the headphones 18. Different environments can be auditioned by adjusting the selected effect in the device 16, and the effect of this can be heard in real time. The mix can be adjusted accordingly using the computing device 10 so that a suitable balance is achieved between the needs of different environments, as required by the artist. Once a set of mix parameters has been chosen, the sound file can be saved by the computing device 10 for use elsewhere.

It should be noted that the saved sound file will not contain effects derived from the device 16. The variations in mix parameters imposed by software on the computing device 10 affect the sound file saved on that computing device, and the DSP effects added to the sound signal are applied to the sound signal after it has been reproduced by the computing device 10 but before it is heard by the user via the headphones 18. The effects therefore form part of the auditioning process but not the mixing process.

In a further development, the DSP device 16 could be integrated into the computing device 10 or into software on that device.

It will of course be understood that many variations may be made to the above-described embodiment without departing from the scope of the present invention.

Although the present invention has been described with reference to preferred embodiments, workers skilled in the art will recognize that changes may be made in form and detail without departing from the spirit and scope of the invention.

1. A combination of a computing device and an audio auditioning device; the audio auditioning device comprising:
a sound input,
a sound output,
a digital signal processor, and
a library of stored digital signal processor effects;
wherein the digital signal processor is adapted to apply a chosen effect from the library to a sound signal provided to the device via the sound input and deliver this to the output,
the library includes a plurality of digital signal processor effects representing the effect on a sound signal of reproduction in different environments;
the computing device including
a stored sound signal,
mixing software adapted to adjust the mix of the stored sound signal, and
a sound output connected to the sound input of the audio auditioning device.

2. The combination according to claim 1 in which the computing device is adapted to retain a sound file for processing by the mixing software.

3. The combination according to claim 2 in which the mixing software is adapted to adjust audio parameters of the sound file and save a new version of the sound file to the computing device.

4. An audio auditioning apparatus comprising:
a sound input,
a sound output,
a digital signal processor, and
a library of stored digital signal processor effects;
wherein the digital signal processor is adapted to apply a chosen effect from the library to a sound signal provided to the device via the sound input and deliver this to the output,
characterised in that
the library includes a plurality of digital signal processor effects representing the effect on a sound signal of reproduction in different
environments, and
the digital signal processor is adapted to apply the chosen effect in real time.

5. The apparatus according to claim 4, further comprising a pair of headphones connectable to the sound output, wherein each of the digital signal processor effects comprises a combination of an environment-specific effect and an effect corresponding to the headphones.

6. The apparatus according to claim 5, wherein each of the digital signal processor effects further comprises an effect corresponding to a human head model.

7. The apparatus according to claim 4, wherein the effect is selected from the group consisting of a home stereo, a home multi channel cinema, a large cinema, a concert hall, a car interior, and a radio receiver.

8. The apparatus according to claim 4, in which each effect is a combination of a loudspeaker model and a room model.

9. The apparatus according to claim 8 in which each effect further includes a human head model.

10. The apparatus according to claim 8 in which the models are derived from impulse responses.

11. The apparatus according to claim 4, in which the digital signal processor applies the effect to the sound signal via both convolution reverberation and Schroeder reverberation.

12. (canceled)

13. The combination according to claim 1, further comprising a pair of headphones connectable to the sound output of the audio auditioning device, wherein each of the digital signal processor effects comprises a combination of an environment-specific effect and an effect corresponding to the headphones.

14. The combination according to claim 13, wherein each of the digital signal processor effects further comprises an effect corresponding to a human head model.

15. The combination according to claim 1, wherein the effect is selected from the group consisting of a home stereo, a home multi channel cinema, a large cinema, a concert hall, a car interior, and a radio receiver.

16. The combination according to claim 1, in which each effect is a combination of a loudspeaker model and a room model.

17. The combination according to claim 16 in which each effect further includes a human head model.

18. The combination according to claim 16 in which the models are derived from impulse responses.

19. The combination according to claim 1, in which the digital signal processor applies the effect to the sound signal via both convolution reverberation and Schroeder reverberation.
